(19) United States
(12) Patent Application Publication
(10) Pub. No.: US 2017/0243167 A1
(43) Pub. Date: Aug. 24, 2017

(54) Method And Apparatus for Real Time Theatrical Audition Management, Coordination and Feedback

(71) Applicants: Joseph R. Popson, II, New York, NY (US); Lawrence Ficek, New York, NY (US)

(72) Inventors: Joseph R. Popson, II, New York, NY (US); Lawrence Ficek, New York, NY (US)

(21) Appl. No.: 15/440,202

(22) Filed: Feb. 23, 2017

Related U.S. Application Data
(60) Provisional application No. 62/298,558, filed on Feb. 23, 2016.

(51) Int. Cl. G06Q 10/10

(52) U.S. Cl. CPC G06Q 10/1053; G06Q 10/1095

(57) ABSTRACT

A method and apparatus for real time theatrical audition management, coordination and attendee feedback in the form of a web based downloadable application which provides a single virtual place for users to read, sort, select and receive information about the current status of a given audition in real time. The method gives audition sponsors real time, effective and efficient audition management tools. All stakeholders in auditions benefit from the method and apparatus disclosed.

### RELATED APPLICATIONS

This application claims priority to U.S. provisional patent application Ser. No. 62/298,558 filed Feb. 23, 2016 entitled “Method and Apparatus for Real Time Theatrical Audition Management, Coordination and Feedback”.

### BACKGROUND OF THE INVENTION

Field of the Invention

The present invention relates to theatrical auditions, and more particularly to a method and apparatus for real time theatrical audition management coordination and feedback.

Background Information

The history of the theater is also the history of theatrical auditions. In the 21^{st} century many auditions are still governed by paper sign-up sheets that date back over a century. Electronic bulletin boards of auditions exist, but they do not allow for management of the individual auditions nor of feedback to participants. Individual auditions may be facilitated by electronic sign up and mass e-mail/text messaging updates to the attendees, but this requires the individual entry of attendees and other interested parties, and does not allow easy feedback to participants or for collection of multiple auditions.

The present invention addresses the deficiencies of the prior art in relation to theatrical audition management coordination and attendee feedback.

### SUMMARY OF THE INVENTION

The present invention addresses the deficiencies of the prior art and provides a one-stop, on-line method and apparatus for real time theatrical audition management coordination and attendee feedback for theatre professionals.

The present invention provides a method for theatrical audition management comprising the steps of: obtaining audition information regarding auditions associated with a plurality of theatrical productions; creating a web based database of auditions from the audition information; accessing the web based database of auditions by potential audition participants via personal electronic devices of the potential audition participants including mobile devices; filtering the web based database of auditions with at least user selectable filters; displaying a filtered subset of the web based database of auditions to the potential audition participants via the personal electronic devices of the potential audition participants; identification by individual potential participants of a set of the filtered subset of the web based database of auditions which the potential participant plans on attending; and creating a journal of the set of the filtered subset of the web based database of auditions the potential participant plans on attending on the personal electronic device of the potential audition participant.

Alternatively the present invention may be described as an apparatus for theatrical audition management comprising: a web based platform configured to obtain audition information regarding auditions associated with a plurality of theatrical productions; wherein the web based platform is configured to create a web based database of auditions from the audition information; wherein the web based platform is configured to allow access to the web based database of auditions by potential audition participants via personal electronic devices of the potential audition participants including mobile devices; wherein the web based platform is configured to filter the web based database of auditions with at least user selectable filters; wherein the web based platform is configured to display a filtered subset of the web based database of auditions to the potential audition participants via the personal electronic devices of the potential audition participants; wherein the web based platform is configured to allow identification by individual potential participants of a set of the filtered subset of the web based database of auditions which the potential participant plans on attending; and wherein the web based platform is configured to create a journal of the set of the filtered subset of the web based database of auditions the potential participant plans on attending on the personal electronic device of the potential audition participant.

These and other advantages of the present invention will be evidenced in the following description taken together with the attached illustrative figures in which like reference numerals represent like elements throughout.

### BRIEF DESCRIPTION OF THE FIGURES

FIG. 1 is a schematic representation of the web based theatrical audition management platform according to one embodiment of the present invention focusing on the pool of auditions for the audition database of the platform and illustrating a variety of users;

FIG. 2 is a schematic representation of a filtered set of available auditions in the web based theatrical audition management platform according to one embodiment of the present invention;

FIG. 3 is a schematic representation of the web based theatrical audition management platform according to one embodiment of the present invention focusing on the audition management of the platform.

### DESCRIPTION OF THE PREFERRED EMBODIMENTS

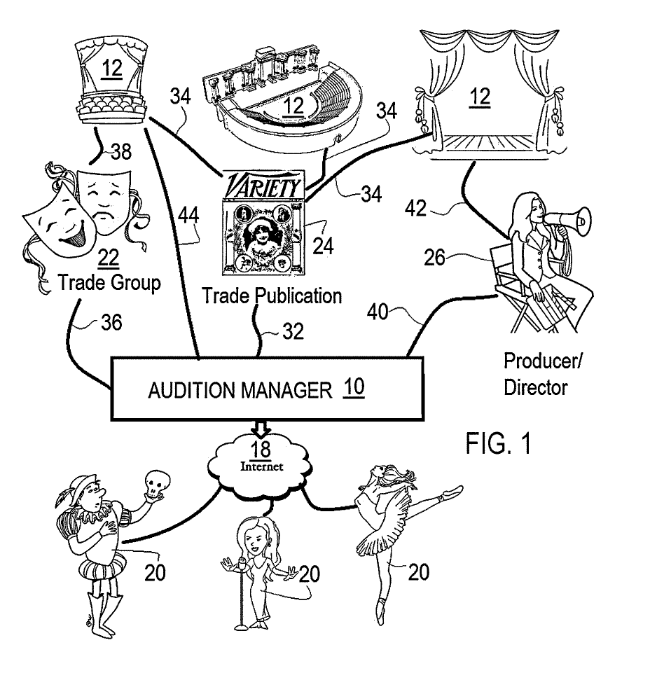

As a brief overview of the invention shown schematically in FIGS. 1-3, the present invention provides an audition manager 10 as an application service provider or ASP, more specifically a vertical market ASP for theatrical audition management. Namely the audition manager 10 is in the business of providing web based audition management, co-ordination and feedback services to customers over the internet 18. As will be evident from the following, the customers of the manager 10 of the present invention can include any and/or all of the stakeholders including the prospective performers or users 20, also called actors and potential participants interchangeably in this context, wishing to go to the auditions, as well as casting director/producer 26 also called sponsors, managing the auditions, trade publications 24 and trade groups 22.

The theatrical auditions begin with a theatrical production, which for the purposes of illustration are represented by the venues 12 in the figures. It is well understood that specific theatrical productions are not always associated with a single venue 12, such as a touring company production, but the venue 12 is helpful for illustration. The theatrical venues 12 are also more expansive than the traditional theaters as schematically shown, and cruise ships, amusement theme parks, and events (such as a parade that does not fit into a single venue construct) are included.

The audition manager 10 maintains a database of known auditions for theatrical productions and obtains this information from a variety of sources. In one source, the manager 10 communicates via link 32 with trade publications 24 which commonly receive the audition information directly from each theatrical production or venue 12 via communication 34. The trade publications 24 within the meaning of this application include any periodical, including only online periodicals that publishes audition information, such as Broadway World, Playbill, Back Stage and Variety. The communication 32 between the manager 10 and the trade publication 24 is via the internet 18 and has the advantage of having generally uniformly formatted data relating to the auditions to be managed. The communications 34 between the individual productions or venues 12 and the trade publication 24 may be in any mode (e-mail, fax, mail, or even oral communication) as is conventional.

A second source for information regarding auditions is communications 36 with trade groups, which may be effectively any group in or generally around the theater environment, such as an actor's guild (SAG), a theatrical department of a university, a community arts support group, and a host of others. The trade groups 22, similar to the trade publications, will receive the audition information in direct communications 38 from the individual productions or venues 12. Some entities that are the source of audition information, such as an online bulletin board like CRAIGSLIST, may be considered either or both of a trade group 22 and a trade publication 24, and the classification of such a “hybrid” source of audition information is not critical for the operation or understanding of the invention.

Alternatively the theatrical production or venue 12 will establish audition requirements that are conveyed (represented by link 42) to a casting director 26 (or producer or general director) who uploads 40 the auditions directly to the manager 10. The uploading 40 differs from the communications 32 and 36 in that the latter two are pulling the data in from existing databases of auditions while the uploading is more accurately described as a pushing of the audition information into the manager 10 from the casting director 26. The direct uploading at 40 gives the casting director 26 greater control over the additional details of the audition to be displayed in the database of the invention then if the casting director 26 supplied the same to trade publications 24 through communication 34 or to trade groups 22 through communications 38. The direct uploading via communication 40 allows the director 26 to have virtual real time management of the audition. Changes to the audition (also made via the uploading 40) can get to the participants 20 in essentially real time, whereas changes made through the trade publication 24 and the trade group 22 have an inherent delay.

The system allows a sponsor 26 to update, via uploading 40, changes to the audition information in the database of an audition for a production or venue 12 associated with that sponsor 26 with the association represented by link 42, and this updating may be of auditions that were not originally uploaded by the director or sponsor 26 (i.e. they were pulled in via communications 32, 36 or 44). The sponsor portal into the system may include a verification that the sponsor 26 is authorized to manage the audition that was not originally uploaded by the sponsor 26, however as the sponsor portal is distinct and more restrictive in terms of ability to access from the user access or portal, the verification may simply be self-authentication by the sponsor 26

A further method of obtaining information for auditions to place in the audition database by the manager 10 is directly pulling from the venues 12 shown via communication 44. This is where the manager 10 accesses and obtains auditions from a series of auditions often across several productions of the venue 12, and is analogous to the access and pulling in of audition information of communications 32 and 36. “Pulling” communications 32, 36 and 44 and “pushing” communication 40 are all electronic communications. The manager 10 may also receive information on auditions off line and manually input the material, but this inefficient method may be made available, but generally should be discouraged as adding unwanted costs to the management of the system.

The database of auditions of manager 10 is accessible by the prospective participants or users 20 of the auditions via the internet 18 on their individual devices 74 (mobile smartphones, tablets, notebooks, laptops, desktops and any electronic device. The present invention provides a web based downloadable mobile application (mobile app), namely a software application designed to run on mobile devices such as smartphones and tablet computers, although it should similarly work on laptops and desktops, namely any electronic device 74 of a user 20.

With the mobile app, the user 20 can access the database of auditions via a user portal into the manager 10 on the internet 18. The database of auditions will include a series of user selectable filters 60 for filtering of the auditions. The most common filters 60 will be time (e.g., auditions today and auditions this week) and geography (e.g. within 50 miles (or a user selected limit) of a set zip-code or the device 74's location, or within given states, etc). The user 20 can set a number of predefined active filters 60 such as age, gender, and calendar availability to only display relevant auditions. The filters 60 can allow for the mandatory inclusion of certain words or exclusions of certain words from the filtered auditions, such as only show auditions including “dancer” or “chorus” do not show auditions including a specific production company or venue. The filter 60 may be audition specific such as when the user 20 reviews an audition that passes previous filters 60 and opts not to see that particular audition again on subsequent listings it will be filtered out of subsequent displays.

Some filters 60, called passive filters, may not be user selectable and may come from the originator or sponsor 26 of the audition (the Trade Group 22, the trade publication 24, the casting director 26 and the venue 12). For example the audition may be filtered out unless the user 20 has proof they are a member or associate of the trade group 22, or that they have sufficient amount of experience or credentials demanded by the Director 26 allow for the originator of the audition to maintain additional passive desired control over the audition.

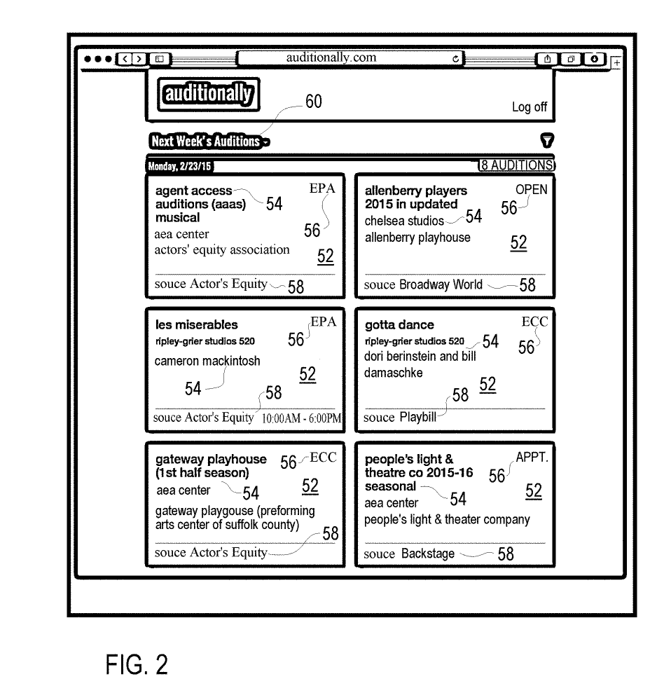

FIG. 2 is a schematic representation of a filtered set of available auditions shown within an application display 50 for a user 20. The listings may be scrollable down or set up in pages. Each audition is displayed in a familiar rectangular notecard arrangement or format 52. The notecard format 52 may also be described as a flashcard format. A flashcard is often defines as a card containing a small amount of information which is held up for students to see as an aid to learning, and the format 52 follows this well-known format.

The notecard 52 has some historical familiarity to those in the theatrical profession, but a main benefit of this format 52 is the scalability of the format 52 between both mobile platforms and larger displays like laptops and desktops. The notecard format 52 allows readability to be maintained regardless of display size. The audition has traditional bibliographic information 54 regarding the audition to allow prospective participants 20 to understand what the production is and the audition is for and the other critical information conventionally displayed for an audition. The bibliographic information 54 may include active links to a webpage for the production or venue 12 or other further background information that may be of assistance to the prospective users 20. Additionally the audition has a classification 56, such as Open, Appointment, ECC, EPA, and Submission. The classification 56 will describe the audition and generally how it will be run. Finally the audition on the notecard format 52 has the source 58 (or sources) of the listing identified to the user 20 to assist in identifying where the information is being gathered.

An important feature of the present invention for the user 20 is that after a suitable filtered audition is selected as appropriate, and the user 20 intends to attend, the audition is moved to a personal log or historical journal specific to that person or user 20. The selecting of the audition may require several steps, such as where it is by appointment only and the user 20 will request an appointment from the casting director 26 who will tentatively give a proposed appointment time and will be notified when the user accepts the proffered time (or the process repeats with an alternative time until a mutually agreeable time is selected). These aspects of the system are handled by conventional calendar software available on almost all smartphones, tablets, laptops and desktops. Even where an appointment is not required and the audition is open (at least in some regard) the invention will for selected auditions integrate with the user's calendar software to block off the time of selected audition, and optionally (for managed auditions) will send the director 26 an indication of the user's indication they will attend so there is a running total of the number of expected or potential attendees that are attending via this invention. The journal of accepted auditions is maintained for the user and allows the user to add notes specific to these auditions. Outside of the added user notes and feedback from the director 26, the journal of accepted auditions will display to the user similar the filtered list shown in FIG. 2. The notecard format 52 is an efficient and easily understood format for displaying this information. The personal notes and director feedback may be accessed via clicking on the individual notecard 52. The journal entries are sortable via user defined filters as well to allow the user to review a desired subset of journaled auditions quickly.

Additionally the user 20 will select desired notifications regarding accepted auditions, such as email or twitter or other desired social media updates for changes, and for conflicts that arise, or reminders of the audition a day or two hours prior to a scheduled audition. The selection of desired notifications is, at first global to all selected auditions, such that the user 20 need only set such notification preferences once, but each individual audition selected may be individually modified. For example a user 20 may have a reminder for a day before and 2 hours before each audition, but an audition at a farther distance from normal may be changed to have a reminder sent a day before and 4 hours before to accommodate the increased travel time. The options available for user 20 defined reminders are limitless, and places no strain on the system. It is anticipated that the system will recommend a set of reminders as a default setting based upon best practices in the industry.

Looking back at past notes in the journal of auditions can be greatly beneficial for the user 20 as they move forward with similar auditions and can reinforce strategies that were successful and help identify strategies that were not.

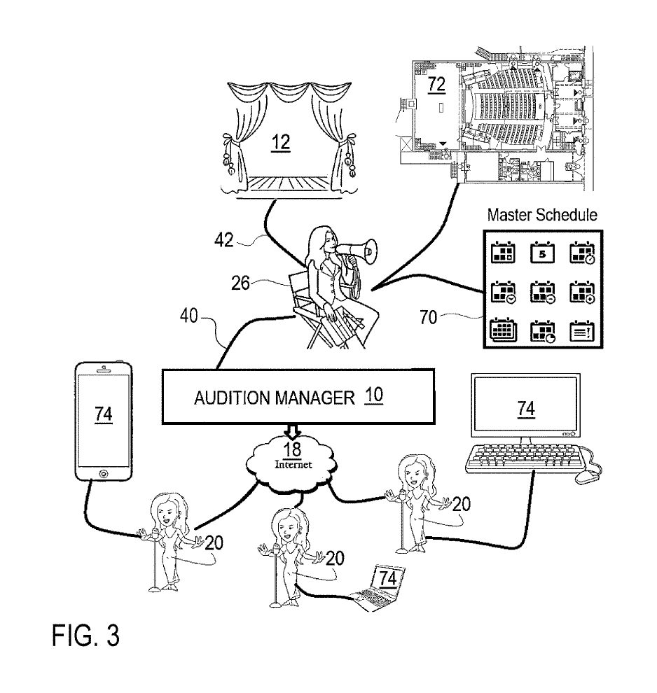

FIG. 3 is a schematic representation of the web based theatrical audition management platform according to one embodiment of the present invention focusing on the audition management of the platform. Here the focus is on one audition for one production or venue 12 in which a series of presumably similar participants 20 have accepted a given audition. Each user 20 will have the particular audition in there journal or log of accepted auditions and each will have their calendar program marked accordingly. The director 26 will have a listing of prospective attendees 20 on an appropriate master schedule 70, which typically includes all the auditions for an entire production at the venue 12 (possibly for more than one production). In theatrical auditions an unavoidable delay in one set of auditions has a cascading effect in the others. The present invention is better than a passive webpage update, as the director 26 updating of the audition in the manager 10 will cause the system 10 to send updates and notifications automatically to the participants 20 via interaction with the calendar software on the user's device 74. Further the director portal to the system 10 will update the master schedule and work out conflicts with the director 26 before updating the relevant auditions. Conflict in rescheduling auditions is again mainly accomplished through interaction with existing calendaring programs of the director's device 74.

The manager 10 will allow the director 26 to provide real time updates to participants 20 outside of time and place updates. For example it may be beneficial for the director 26 to allow the participants 20 for the ongoing or upcoming audition know that the producer or investor or other particular stakeholder is now in the current (or upcoming) audition. This becomes practical with the real time manager 10 of the present invention.

A similar but separate aspect of the present invention is to allow select users 20, called moderators, make comments on auditions that can be added to the listing in real time by the manager 10 of the invention. Here the moderators (select users 10) can advise objectively on ongoing auditions in real time, such as who is in the room (director/producer/casting team) and who is no longer in the room, and the general nature of the audition. As the moderators would be commenting on auditions of third parties, and would likely be actively participating in the auditions themselves, the moderators would likely be a selected subset of users 20 that are trusted with meaningful inputs. The real time moderator updates may be available to premium member level users 20 of the manager 10. The system may include a delay in which moderator comments can be verifies, such as confirmation from a sponsor 26 or another moderator.

The director 26 has access to the manager 10 through a director's portal that differs from the user's access in that it allows for the management of auditions. Thus the history of the auditions maintained on the master schedule 70 include the list of attendees and gives the director a simple and comprehensive place to keep notes to assist in making casting decisions. These notes can also be of great interest to the users 20. Knowing that the director 26 of an unsuccessful audition for the user 20 labeled the user's performance as “too perky”, “too soft”, “too hard”, etc. can be of great benefit to the user 20. The present system allows these comments (although typically very brief and possibly cryptic) to be shared with the user 20, with the directors or sponsors 26 permission. The system will allow the director 26 to list public and private comments with only the public comments being sent back to the users 20. Again even short feedback from a casting director 26 will be of great interest to the users 20, even if the user 20 is not in agreement with the proffered assessment.

Another important feature of the platform of the present invention is the ability to provide site maps 72 associated with each audition. Theaters are not typically the easiest buildings to navigate and participants 20 are often showing up to a location they have not been to before and are given a limited time to make it there. The director 20 may be casting a number of parts in a single day and may have very strict guidelines about when a user 20 can appear such that a user 20 may not be welcome too early before a scheduled audition as such creates too many people to handle at the venue 12. A site map can alleviate some of the anxiety with making it to a previously unknown location in a very limited time frame. The site map 72 may include directions to the building itself, although smartphones already have numerous applications available to get users 20 to the building in general and the site map 72 is primarily intended to get users through the proper entrance down the correct corridor to the precise part of the often large and complex building. Site maps 72 of most venues already exist with historically participants 20 often getting them AFTER they have been to a location and the need for such a map is greatly diminished. The site map 72 places users 20 who have never been to a venue 12 on somewhat equal footing with those that have been to the venue 12. Additionally many venues 12 have entrances that are quite distant in terms of access from the exterior, such as where a side entrance that may only be a few feet from a front entrance is only accessed via a different access road (e.g. going around to the side of the building from the front means actually going around the block and around several other buildings entirely). Thus the site map can be of great assistance even to those familiar with the venue 12 by identifying the proper entrance that will be open for a given audition.

The platform described provides a single virtual place for users 20 to read and provide information about the current status of a given audition in real time. It is anticipated that users 20 who are “members” will be able to access certain functionality based on the status of their account.

The application according to the present invention will allow for casting directors 26 and theatres or venues 12 to host a real time digital sign up list for their auditions. The auditioning application according to the present invention provides a tool for both the actor 20 trying to book the job, and for the sponsor 26 in the behind the table journey to casting a show.

The application is a web based application that will be available for anyone via the internet 18, on all of their computer devices 74.

The application of the present invention simplifies the audition process by providing accurate, near real time information to the actors 20 throughout the audition.

The sponsor or director 26 who actively lists an audition will place the conventional information that is provided in audition listings, namely the desired requirements of the audition attendees and the time and place of the auditions. Note the sponsor 26 may make the requirements a passive filter 60 and thus automatically require the users 20 who attend to meet the designated requirements. Additionally the system allows the sponsor 26 to limit the attendees and to assign relevant audition times for the attendee. More critically the system allows the sponsor 26 to easily and effortlessly update the auditions in real time, i.e. changing the location and or time of the auditions with directions/instructions relevant to the change. The actors 20 have one place to review and to sort through a number of auditions as well as providing a history of the attendee's auditions, and possibly more critically providing a vehicle for providing personalized feedback to individual attendees from individual auditions.

The invention gives the actors 20 information in one convenient place, and helps the casting team (collectively 26) move through the complicated process more smoothly. The invention allows the casting director 26 to be able to conveniently provide feedback to actors 20 who audition, as well as allowing the sponsor 26 to sort their own notes for attendees 20 of their audition. Thus the actor 20, after their audition, can receive the personal feedback digitally. The casting director 26 will be able to designate private notes (those not shared with the individual attendee 20, but used internally for managing the audition) and public notes that may be shared with the attendee 20.

The application of the present invention will be available on all devices 74 via a web site, such as http://www.auditionally.com accessed via the internet 18. The invention will work and interact as an application and some services on the site will work with little to no cellular connectivity after initial load of the website. The end user 20 will be able to sign up and create a new account on the hosted site, or directly log in with a social networking site such as with their Google or Facebook account.

The invention is applicable for the management and co-ordination of every open call or other audition. Further the invention allows the system to list auditions that are not being managed through the system, i.e. repeating an open call listing from a trade journal 24. These non-managed auditions would still allow users 20 to filter or sort, review and schedule such auditions that would be maintained in their personal logs and histories (their journal), but would not yield the real time management advantages or feedback advantages of the system, unless a sponsor 26 elects to manage such an audition with the system. Similarly the system allows individual users 20 to add non-managed and non-database auditions to their own listings (which would thus not be searchable to other users 20) so they can keep their own logs or journals up to date, but such outside entries similarly do not yield all the advantages of the present invention.

The user 20 may use the invention as a tool that allows them to focus on what they are attempting to do, namely book the job. The service will work on any internet compatible device 74 (smart phones, notebook PC, PCs, Netbooks, tablets, electronic readers, pda's etc) that they own on any operating system such as, but not limited to Mac, PC, Linux, iPhone, iPad, Android, Blackberry, Windows OS, etc).

The present invention allows users 20 to browse for auditions in one place, to Create their own individualized Audition Board after they sign up, and to Sync their Auditions to their phone/computer calendar. The system scales to whatever device 74 the user 20 is on and will track past auditions and allow for an Audition Journal to keep in the user's private account. Significantly the system allows for the user to receive feedback via the App after audition. Further the system allows the user the ability to filter auditions based on user selectable filters 60 such as audition type, region, or any other desired parameter.

The system or platform of the present invention provides the sponsor 26 or Producer/Audition Holding entity side with comprehensive audition management tools. One such management tool is the passive filters 60 providing automatic review of qualifications of potential audition upon signing up (e.g., the range of ages for the part of 45-75 years old is automatically checked against the stated date of birth of the actor 20; or the membership number in SAG of a user 20 is checked if this is a requirement and the system can be coupled to available databases such as SAG membership databases, prior auditions in the system by this member, etc and can actually check these for discrepancies or values).

Further to facilitate the use of the system by the casting director 26, the system allows rating of each performer 20 in a number of director 26 defined fields (e.g. Appearance, Voice, Presence, Total score (which itself can be user defined such as 2× Appearance value+Voice and 1.5×Precense) and the results can be sorted by the desired fields. Storing audition sound and video can allow for collaborative casting input from parties that are remote.

The system has private notations not intended to be shared with performer 20 (such as the ratings) and “public” notations that are intended to be sent back to the individual user 20. This functionality alone can yield a unique implementation model for facilitating use and adoption of this system. The system yields one stop management of auditions whereby changes to the auditions are made across the board and system will send updates to participants accordingly (via e-mail, Facebook, twitter, etc.) and other stakeholders (Artist Agency contacts, investors, facility coordinator, accompanists, videographers, etc.). The “other stakeholders” are not described separately but may be considered as users 20 whose participation in a given audition is selected by the sponsor 26 (such as for investors, facility coordinator, accompanists, and videographers) or the actor 20 (Artist Agency contacts) rather than by the user 20 themselves.

The Artist or Actor Side audition management tools provided by the present invention include harnesses the power of the artist's available online casting profile which includes their Images, Bibliographic Statistics, Agency Contact Details, Resume and other media) and Auto fill in of background fields for Producers 26 using system (i.e. if the producer 26 is using this system then when the artist 20 attempts to sign up for the audition the system will auto fill in a number of bibliographic fields not specific to this part for the actor 20—which fields, of course could be modified by the artist before submission—but the system greatly increases the speed and accuracy of filling out the submissions). The automatic updating of the actors 20 scheduling can also include actor defined notifications (e.g. the actor may have the system send him a twitter update when a given schedule is adjusted, or text message a day or number of hours before each audition as well as conflict notifications). As discussed above the system includes the ability to add out of system auditions.

The system is useful for other stakeholders (users 20 whose interest in specific auditions is generally selected by sponsors 26 or audition participants 20) in the process as briefly mentioned above, such as, talent agencies which can automatically coordinate and manage auditions for each of their clients via the system.

As another third party stakeholder a facility coordinator for a venue 12 can encourage/demand use of the system by productions that are using their venue 12 so that there is an automatic a verifiable record of who is using the facilities at least for auditions and the participants 20 attending such auditions. The facility coordinator dashboard would integrate all of these productions and would avoid conflicts between simultaneous use of the same part of the venue 12 by competing productions.

Investors represent a class of system user that may have a distinct portal dashboard options, i.e. actors 20 for an audition on this dashboard may be evaluated upon their effect on the budget which the casting director 26 would not have a concern (at least at first). Additionally the investors may not access to the “Public comments” which are between the casting director 26 and the actor 20.

Other audition support members, such as a pianist or guitar accompanist, for example, would be helped by the system to automatically updating them with changes and allowing them to co-ordinate automatically with other jobs. Their own journal of upcoming and past jobs can thus be helpful, as will notes of past jobs (e.g., the preferences of a given casting director 26).

The present system is easily adapted to the needs of the Casting Professional 26 and those auditioning Artists, who needs typically varies with every project. For example, while a film or TV project will have a larger allotted time per Artist 20 in a given audition, typically auditioning individually and reading from a script, with a commercial casting professionals, typically there is a lot more people to audition, time slots are shorter sometimes 5 min or less and many times they are running Group Auditions, seeing a person from each key role in the one audition interacting with each other. The present platform is flexible, and provides a simple way to group people together, a way to define the time quickly and easily for the sponsor 26.

The website hosting the manager 10 of the present invention may and certainly will have numerous other aspects that are only tangentially relevant to the present invention, such as forums for all or select groups of the stakeholders, industry blogs, and links to other useful sites. The method and associated platform or apparatus for real time theatrical audition management, coordination and attendee feedback as described above provides a single virtual place for users to read, sort, select and receive information about the current status of a given audition in real time. The method and associated platform gives audition sponsors real time, effective and efficient audition management tools. All stakeholders in auditions benefit from the method and apparatus disclosed above.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A method for theatrical audition management comprising the steps of:
Obtaining audition information regarding auditions associated with a plurality of theatrical productions;
Creating a web based database of auditions from the audition information;
Accessing the web based database of auditions by potential audition participants via personal electronic devices of the potential audition participants including mobile devices;
Filtering the web based database of auditions with at least user selectable filters;
Displaying a filtered subset of the web based database of auditions to the potential audition participants via the personal electronic devices of the potential audition participants;
Identification by individual potential participants of a set of the filtered subset of the web based database of auditions which the potential participant plans on attending;
Creating a journal of the set of the filtered subset of the web based database of auditions the potential participant plans on attending on the personal electronic device of the potential audition participant.

2. The method for theatrical audition management according to claim 1 further including the step of allowing the user to add notes specific auditions within the journal of accepted auditions.

3. The method for theatrical audition management according to claim 1 further including the step of adding feedback from the director to an individual users journal of accepted auditions.

4. The method for theatrical audition management according to claim 1 further including the step of adding user defined notifications for accepted auditions of the user.

5. The method for theatrical audition management according to claim 1 further including the step of maintaining sponsor notes by a sponsor of an audition regarding the participants of the audition on the system.

6. The method for theatrical audition management according to claim 5 wherein the sponsor's notes include private notations not intended to be shared with an individual user and public notations that are sent back to the individual user and maintained in the user's journal.

7. The method for theatrical audition management according to claim 5 wherein the sponsor's notes include a sponsor defined rating system for each user.

8. The method for theatrical audition management according to claim 5 including the step of maintaining a master schedule for a sponsor of a plurality of auditions for a theatrical production.

9. The method for theatrical audition management according to claim 8 including the step of updating an audition time or location or requirements by a sponsor and notifying the potential participants of the change.

10. The method for theatrical audition management according to claim 5 including the step of sponsor selective passive filter requirements for auditions which automatically require the users who attend to meet the designated requirements by preventing display of auditions to users who fail to meet the passive requirements.

11. The method for theatrical audition management according to claim 1 including the step of providing site maps associated with select auditions.

12. The method for theatrical audition management according to claim 1 including the step of displaying each audition to the user is a rectangular notecard format on the user's device.

13. The method for theatrical audition management according to claim 1 wherein the journal of auditions the potential participant plans on attending stored on the personal electronic device of the potential audition participant is sortable by user defined filters.

14. The method for theatrical audition management according to claim 1 adding non-managed and non-database auditions to the journal of auditions the potential participant plans on attending stored on the personal electronic device of the potential audition participant.

15. The method for theatrical audition management according to claim 1 further including the step of creating a journal of relevant auditions for other stakeholder on a personal electronic device of the other stakeholders.

16. The method for theatrical audition management according to claim 15 wherein the journal of relevant auditions for other stakeholder include auditions selected by sponsors or users.

17. The method for theatrical audition management according to claim 1 wherein the obtaining audition information regarding auditions associated with a plurality of theatrical productions comes from a plurality of distinct sources including at least two sources of trade groups, venues, trade publications and production sponsors.

18. The method for theatrical audition management according to claim 17 wherein the plurality of distinct sources including at least one source of each of a trade group, a trade publication and an individual production sponsor.

19. The method for theatrical audition management according to claim 1 further including access by third party stakeholders including at least one of production investors, facility coordinators and audition support members.

20. An apparatus for theatrical audition management comprising:
a web based platform configured to obtain audition information regarding auditions associated with a plurality of theatrical productions;
wherein the web based platform is configured to create a web based database of auditions from the audition information;
wherein the web based platform is configured to allow access to the web based database of auditions by potential audition participants via personal electronic devices of the potential audition participants including mobile devices;
wherein the web based platform is configured to filter the web based database of auditions with at least user selectable filters;
wherein the web based platform is configured to display a filtered subset of the web based database of auditions to the potential audition participants via the personal electronic devices of the potential audition participants;
wherein the web based platform is configured to allow identification by individual potential participants of a set of the filtered subset of the web based database of auditions which the potential participant plans on attending; and
wherein the web based platform is configured to create a journal of the set of the filtered subset of the web based database of auditions the potential participant plans on attending on the personal electronic device of the potential audition participant.
